(19) United States
(12) Patent Application Publication
(10) Pub. No.: US 2025/0333266 A1
(43) Pub. Date: Oct. 30, 2025

(54) ELEVATOR AND ACCESS SYSTEM

(71) Applicant: Kone Corporation, Helsinki (FI)

(72) Inventors: Jukka SALMIKUUKKA, Helsinki (FI); Pekka KORHONEN, Helsinki (FI); Teppo VOUTILAINEN, Helsinki (FI); Ari VARELIUS, Helsinki (FI)

(73) Assignee: Kone Corporation, Helsinki (FI)

(21) Appl. No.: 19/061,298

(22) Filed: Feb. 24, 2025

Related U.S. Application Data
(62) Division of application No. 16/162,572, filed on Oct. 17, 2018, now abandoned.
Application No. 16/162,572 is a continuation of application No. PCT/EP2016/059418, filed on Apr. 27, 2016.

(51) Int. Cl. B66B 1/46; B66B 13/14

(52) U.S. Cl. CPC B66B 1/468; B66B 1/46; B66B 13/14; B66B 2201/4615; B66B 2201/4653; B66B 2201/4676

(57) ABSTRACT

An elevator and access system of an environment including an elevator group with an elevator car movable along a vertical pathway. The system includes an elevator control controlling operation of the elevator group and implementing access control of the environment; and an access controlled delivery locker having a locker hatch with a hatch lock, the locker hatch being connected to an access I/O device that communicates with the elevator control. The elevator control is connected with a public communication network and communicates with a mobile phone holding access rights in the environment via the public network. The mobile phone communicates with the access control to unlock the hatch lock of the access controlled delivery locker, and forwards access data for the access I/O device of the access controlled delivery locker to a mobile delivery communication device for unlocking the hatch lock of the access controlled delivery locker.

### CROSS-REFERENCE TO RELATED APPLICATIONS

This application is a divisional of U.S. application Ser. No. 16/162,572, filed on Oct. 17, 2018, which is a continuation of PCT International Application No. PCT/EP2016/059418 which has an International filing date of Apr. 27, 2016, the entire contents of which are incorporated herein by reference.

### BACKGROUND

The present invention relates to an elevator and access system of an environment comprising at least one elevator car which is movable along a vertical pathway and an elevator control being connected with an access control of the environment, the elevator control controlling said at least one elevator car.

The background of this invention is that the volume of on-line shopping has exploded and the growth is expected to continue. This has changed the logistics industry as earlier the majority of the deliveries were targeted to b2b, meaning that the respondent was usually easy to reach during office hours and it was relatively easy to achieve high level of efficiency in delivery operations. Now, the number of home deliveries has already exceeded the b2b deliveries in several market areas and logistics companies face new challenges:
During the day-time, delivery companies have difficulties in getting access to the buildings due increased security and access control in residential buildings.
Recipients are in many cases difficult reach, leading to increasing number of failed delivery attempts.
Recipients are typically reached only during the evenings, leading to inefficiencies in the resource usage as the capacity can't be utilized during the day-time when the peak-hours are in the evenings.
The delivery companies have introduced certain delivery box elements that can be placed e.g. to building lobby. These are separate boxes that typically require some electricity and connectivity to some back-office systems. Bringing these functionalities create significant costs and prevent commercially viable operations unless the building is large and has high volumes of deliveries

On the other hand, the delivery recipients face following problems:
When deliveries happen during the evenings and logistics company can't provide exact time of delivery, the customer is tied to home location waiting the delivery over certain time window (e.g. between 5 and 8 pm). This is annoying and causes frustration and poor usage of customer's resources, leading to negative service experience.

### SUMMARY

It is therefore object of the present invention to improve this combined elevator and access system as to facilitate the delivery of parcels to individuals living in the environment particularly if they are not at home.

The object is solved with an elevator and access system according to claim 1. Preferred embodiments of the invention are subject-matter of the dependent claims. Preferred embodiments of the invention are also described in the description and the drawings of the present patent application.

The solution is built from the combination of two main elements: Smart entrance access+smart integrated delivery box

The entrance access may comprise:
Wireless (Bluetooth low energy or similar) access solution for the access (front) door with possible video intercom to customer's smart phone to enable remote opening of access door
Alternatively back-office access system can have remotely send (one-time) access data pushed to the delivery person's smart phone to provide the access to the building

The integrated delivery locker may have the following features:
the delivery locker can be integrated to the landing door structure of an elevator
the delivery locker can utilize the physical space inside the landing door frames
the delivery locker can have the required electricity from the elevator system electrification
the delivery locker can utilize elevator system's remote connectivity to cloud etc. back-office systems the delivery locker locking system can be integrated with the entrance door access system

A one-time access may be provided for the door as also for locking the delivery locker.

The tenant's or recipients mobile access app may open the delivery locker when his smart phone is within a defined distance of the box

The system comprises on that behalf at least one access door to the environment, which access door has a door lock controlled by the access control, whereby in connection with the access door a first access I/O device controlling the door lock is located, which device is configured to communicate with the access control. The system further comprises at least one access controlled delivery locker having a locker hatch with a hatch lock, whereby in connection with the locker hatch a second access I/O device controlling the hatch lock is located, which device is configured to communicate with the access control.

According to the present invention, the above specified elevator and access system is configured so that the elevator control and/or the access control is/are connected with a public communication network, via which the access control is configured to communicate with at least one first mobile phone (smartphone) holding access rights in the environment. This mobile phone is held by a tenant of said environment which first mobile phone is preferably a smartphone with the ability to display a video stream. The first mobile phone is configured to communicate with the access control either to unlock the door lock and the hatch lock or to forward access data to a communication device of a delivery person which access data is provided for the first and second access door I/O devices to unlock the door lock and the hatch lock.

The inventive elevator and access system allows the delivery person of a delivery company to enter the access door as well as to unlock the hatch of a delivery locker as to place a parcel therein in absence of the recipient, who is usually a tenant or employee in the environment (building). The inventive system thereby offers different routes to enable the invention. Vice versa, the tenant of a building could deposit a parcel in a delivery locker of the building and inform a delivery company to pick up the parcel during his absence. Also in this case the access system has to provide access data in the above mentioned sense, so that the delivery person is able to access the building (access door) and to open the locker.

Generally the invention could also include only the handling of the delivery locker without handling the access door or vice versa. Accordingly, the invention could relate to an elevator and access system of an environment comprising at least one elevator group with at least one elevator car movable along a vertical pathway and an elevator control being connected with an access control of the environment. The system further comprises
at least one access door to the environment, which access door has a door lock controlled by the access control, whereby in connection with the access door a first access I/O device controlling the door lock is located, which device is configured to communicate with the access control.

Alternatively to said access door or additionally to it the system comprises at least one access controlled delivery locker having a locker hatch with a hatch lock, whereby in connection with the locker hatch a second access I/O device controlling the hatch lock is located, which device is configured to communicate with the access control.

The elevator control and/or the access control is/are connected with a public communication network, via which the access control is configured to communicate with at least one first mobile phone holding access rights in the environment, whereby the first mobile phone is configured to communicate with the access control either to unlock the door lock and/or the hatch lock or to forward access data for the I/O devices to a delivery communication device for unlocking the door lock and/or the hatch lock.

On one hand, today customers are informed about a delivery of a parcel in connection with the delivery date. Thus, in one embodiment of the invention, the first mobile phone is configured to issue an access request to the access control which access request comprises the ID of a delivery communication device of the delivery company and/or of the delivery person, whereupon the access control forwards to said communication device ID access data for the first and second I/O devices. The delivery communication device might be a server of the delivery company which receives access data, e.g. access codes, for example via Internet from the access control. The access control may have a memory for access data in connection with a timetable so that access data given to delivery companies is only valid on the delivery date and even there only for a delimited time period or a one-time use (one opening of the delivery locker). The server of the delivery company can of course be connected with smartphones of employed delivery persons so that the access data can be transferred to the smartphones of the delivery person delivering the envisaged parcel. Therefore, the access data might not only be a code which might be inputted in a decade keyboard of the access I/O devices of the access door and the door locker but the access data may also be an access signal which can be transmitted via the smartphone of the delivery person to a broadcasting receiver located in connection with the access I/O device of the access door and the door locker, e.g. Bluetooth® receiver. This means that the delivery person is able to enter the building as well as to open the delivery locker to deposit the parcel in absence of the recipient, preferably only for a limited time period and/or for a one-time use.

Preferably, the access data is a signal to be forwarded via a short range transmission device, e.g. via Bluetooth® between the smartphone of the delivery person and the access I/O device of the access door and the delivery locker.

In a second embodiment of the invention, the operation (pushing) of a bell button located at the access door of the building could be forwarded to the first mobile phone of the recipient via the access control. Thereafter the recipient is able to activate a video device in connection with the access door to monitor which person has pushed the bell button. Thereafter, he is able to unlock the access door via a signal given to the access control via his smartphone. The same is possible with the opening of the delivery locker. This embodiment has the advantage that the delivery has not to be registered beforehand. Further no access data has to be forwarded to the delivery person. But this embodiment has the severe disadvantage that the recipient has to be available on his smartphone.

Of course, each tenant (recipient) may have his own delivery locker in the environment. Anyway, as the delivery of parcels happens not that often, it is possible that the number of the delivery lockers in an environment is much lower than the number of the tenants living there. This means that the delivery lockers are shared by all tenants of the environment. In this case, the access control informs the recipient via the first mobile phone which delivery locker number has received his parcel. The access system then registers the ID of the recipient's first mobile phone as to open the hatch lock of the delivery locker or an access code is issued to the first mobile phone of the recipient to open said locker. In both cases, the recipient is informed about which delivery locker contains his parcel and further he gets the necessary information or data as to open said particular locker.

The access system comprises preferably a reset mechanism as to reset the status of a delivery locker after the locker hatch has been opened by the recipient or after a certain time period has passed after the delivery date. In this case, the access control registers the status of the corresponding delivery locker as free or available.

In a preferred embodiment of the invention, the access system is integrated with the elevator system so that the elevator is also responsible for providing an access control in the environment, for example by transporting persons only to the destination which is available from their first mobile phones. Via this feature, the invention advantageously integrates the function of the transportation and of the access control in the environment, particularly a building.

With the present invention, the system provides entrance access to the environment, particularly a building, as well as access to the delivery lockers located in the building in the above way.

The functionality of the mobile phones in connection with the access system is preferably provided via an App which has to be implemented on the operating system of the mobile phone, preferably smartphone.

As the access control to the access door as well as to the delivery locker can simply be realized via an entrance code which is to be inputted on a decade keyboard of the access I/O devices of the access door and the delivery locker, the delivery person does not necessarily need a mobile device for gaining access as he only needs to memorize the access codes for the access door and the delivery locker, e.g. by making a note.

Of course, a solution where access data is transmitted directly into the mobile communication device of the delivery person is advantageous because in this case the access signal is directly transmitted from his mobile communication device to the receiver of the access I/O device of the access door and the delivery locker so that he does not need to write down or to memorize access codes.

Preferably, the number of elevators and delivery lockers is dependent on the size of the environment. For example, each ten persons may share two or three delivery lockers. So in a building where 100 tenants are residing, at least 10 to 20 access controlled delivery lockers should be provided as nowadays more and more shopping is performed online, as mentioned above.

The above mentioned embodiments can be combined with each other arbitrarily.

Following terms are used as a synonym: tenant—recipient; locker—delivery locker; communication device—delivery communication device.

### BRIEF DESCRIPTION OF THE DRAWING

The invention is hereinafter described via an example in connection with the schematic drawing, wherein:

FIG. 1 shows an access system with an integrated elevator and access control as well as three delivery lockers and an elevator group.

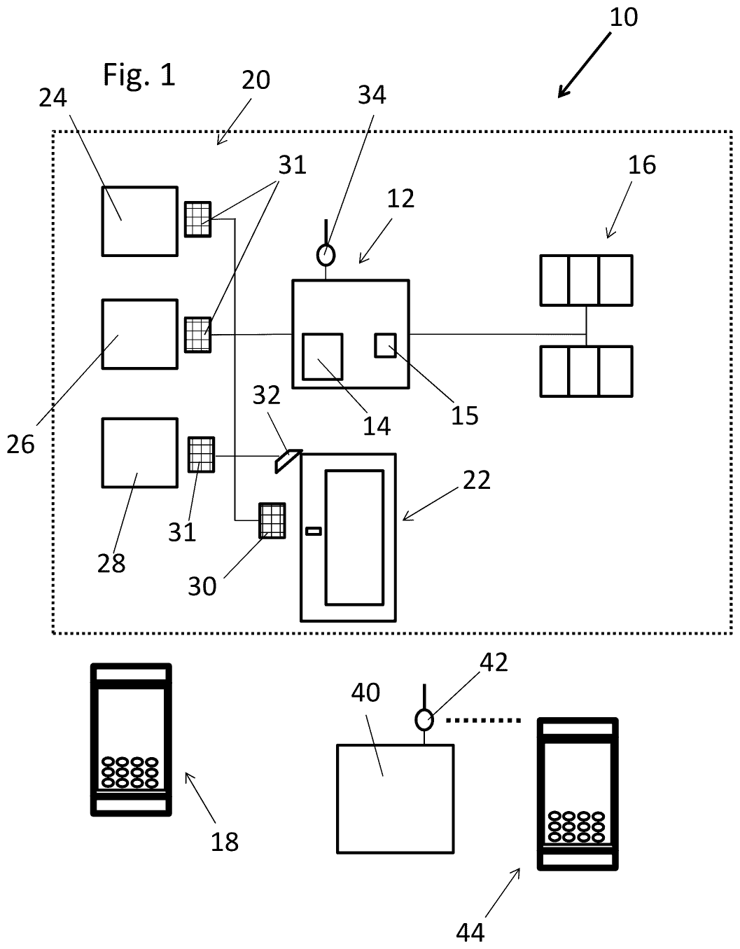

### DETAILED DESCRIPTION

The elevator and access system 10 comprises an elevator control 12 comprising a preferably integrated access control 14, which can however also be placed separately from the elevator control. The elevator control 10 controls an elevator group 16 comprising six elevators. The elevators of the group 16 are preferably destination controlled via first mobile phones 18 carried by tenants of the environment or building where the elevator and access system 10 is installed. The elevator control 12 gets the destination for an elevator ride directly via signal transmission from the first mobile phone 18 so that the elevator control 12 also implements a kind of access control in connection with the preferably integrated access control 14. The environment 20 which is for example a residential or office building has at least one access door 22, several delivery lockers 24 to 28, whereby in connection with the access door 22 a first access I/O device 30 is located. In connection with each delivery locker 24 to 28, a corresponding second access I/O device 31 is located. Each access I/O device 30, 31 preferably comprises a decade keyboard and/or a receiver or transmitter to receive access data from a mobile phone 18, preferably short-range.

In connection with the access door 22, a video camera 32 is located which is also connected to the access control 14. The elevator control 12 comprises a transmission device 34 which is either a broadcast connection and/or a LAN access to a public communication network as e.g. Internet/(mobile) phone network.

With the reference number 40, the server of a delivery company is designated which server 40 comprises its transmission device 42 to communicate with a public communication network as for example a (mobile) phone network and/or Internet. The server 40 as one part of a delivery communication device also comprises a connection to a mobile communication device 44 of a delivery person (as further part of the delivery communication device) which delivers parcels to several environments 20. The mobile communication device or smartphone 44 may preferably be connectable to the server 40 of the delivery company either via a cable or wireless, for example via a short range transmission device, e.g. Bluetooth®.

Usually, in course of a delivery of a package, a recipient which is a tenant in the environment 20 gets an information via the server 40 of the delivery company when a delivery of a parcel is to be expected. This information may for example be transmitted via Internet or via a public broadcasting network to the first mobile phone 18 of the tenant and recipient of the parcel. The tenant receives from the delivery company information about when his delivery is to be expected. The delivery company further forwards the ID of the delivery server or the mobile phone number of a mobile communication device 44 of a delivery person of the delivery company. The tenant thereafter issues an access request for said delivery date to the access control 14 via his mobile phone 18 or via a desktop computer or tablet. The access control thereafter reserves one of the delivery lockers 24 to 28 if available, and informs the tenant via his first mobile phone 18 as well as the delivery company either via the server 40 or directly via the mobile communication device 44 of the delivery person about access data to the access door 22 as well about the ID, e.g. number, of the allocated delivery locker 24 to 28 and corresponding access data. With this information, the tenant as well as the delivery person receive information which delivery locker is to be used for the delivery of the parcel so that the delivery person can access the access door 22 as well as the allocated delivery locker 24 to 28 with the access data received via the access control 14. Furthermore, the tenant 18 receives the corresponding access data via his first mobile phone 18 so that he is able to open the allocated delivery locker later on.

After having opened the delivery locker to receive the parcel, the access control may automatically reset the status of the delivery locker to “available” or the reset of the status of the delivery locker to “available” may be performed after a certain time period. Thus, the system is able to guarantee an easy delivery of parcels during absence of the recipient whereby a high degree of safety is provided.

The access control 14 might further inform the recipient via his first mobile phone that all delivery lockers are reserved at the delivery date, in which case the recipient is able to contact the delivery company and ask for a different delivery date. Therefore, the access control is preferably configured to issue a status signal (reserved/available) of the delivery lockers to the recipient if all delivery lockers are reserved.

The invention is not delimited to the described embodiment but can be varied within the scope of the appended patent claims.

### LIST OF REFERENCE NUMBERS

10 elevator and access system
12 elevator control
14 access control
16 elevator group
18 first mobile phone-smartphone
20 environment-building
22 access door
24 delivery locker
26 delivery locker
28 delivery locker
30 first access I/O device
31 second access I/O device
32 video camera
34 transmission device of the elevator control
40 server of delivery company
42 transmission device of the server
44 mobile communication device

1. An elevator and access system of an environment, the environment including at least one elevator group including at least one elevator car movable along a vertical pathway, the elevator and access system comprising:
an elevator control configured to control operation of the at least one elevator group and implement access control of the environment; and
at least one access controlled delivery locker, each access controlled delivery locker from among the at least one access controlled delivery locker having a locker hatch with a hatch lock, the locker hatch being connected to an access I/O device configured to control the hatch lock, and the access I/O device being configured to communicate with the elevator control,
wherein
the elevator control is connected with a public communication network,
the elevator control is configured to communicate with at least one first mobile phone holding access rights in the environment via the public communication network, and
the at least one first mobile phone is configured to communicate with the elevator control to unlock a first hatch lock of a first access controlled delivery locker from among the at least one access controlled delivery locker, and forward first access data for a first access I/O device of the first access controlled delivery locker to a mobile delivery communication device for unlocking the first hatch lock of the first access controlled delivery locker.

2. The elevator and access system according to claim 1, wherein
the at least one first mobile phone is configured to issue an access request to the elevator control, the access request comprising an ID of the mobile delivery communication device, and
the elevator control is configured to forward the first access data to the mobile delivery communication device having the ID included in the access request.

3. The elevator and access system according to claim 1, wherein
the first access I/O device comprises an input device,
the first access data comprises an entrance code, and
the first access I/O device is configured to unlock the first hatch lock of the first access controlled delivery locker responsive to manual input of the entrance code to the input device by a delivery person associated with the mobile delivery communication device.

4. The elevator and access system according to claim 2, wherein
the access request comprises a delivery date; and
the elevator control is configured to register the first access data for a limited time period on the delivery date.

5. The elevator and access system according to claim 1, wherein
the first access I/O device of the first access controlled delivery locker comprises a short range broadcast receiver, and
the mobile delivery communication device is configured to transmit the first access data to the short range broadcast receiver via short range transmission.

6. The elevator and access system according to claim 1, wherein the mobile delivery communication device is connectable to a server of a delivery company corresponding to the mobile delivery communication device.

7. The elevator and access system according to claim 1, wherein the elevator control comprises an integrated access controller configured to implement the access control.

8. The elevator and access system according to claim 1, wherein the elevator control is configured to
receive, from the at least one first mobile phone, indication of at least one destination floor from among floors within the environment, and
block access via the at least one elevator car to floors from among the floors within the environment other than the destination floor.

9. The elevator and access system according to claim 1, wherein
the at least one access controlled delivery locker comprises a plurality of access controlled delivery lockers,
each access controlled delivery locker from among the plurality of access controlled delivery lockers is assigned to a corresponding tenant from among a plurality of tenants of the environment, and
the elevator control is configured to forward access data corresponding only to one access controlled delivery locker from among the plurality of access controlled delivery lockers to the mobile delivery communication device based on an access request received from a tenant from among the plurality of tenants corresponding to the one access controlled delivery locker.

10. The elevator and access system according to claim 1, wherein
a number of access controlled delivery lockers from among the at least one access controlled delivery locker is less than a number of tenants of the environment, and
the elevator control is configured to issue an ID of an allocated access controlled delivery locker from among the at least one access controlled delivery locker to the at least one first mobile phone and the mobile delivery communication device.

11. The elevator and access system according to claim 1, wherein the elevator control is configured to
send at least one of an ID of the first access controlled delivery locker and the first access data to the at least one first mobile phone.

12. The elevator and access system according to claim 1, wherein the at least one access controlled delivery locker comprises a plurality of access controlled delivery lockers, and
the elevator control is configured to
maintain a status table indicating an available status and a reserved status of each of the plurality of access controlled delivery lockers, and
set in the status table a second access controlled delivery locker from among the plurality of access controlled delivery lockers having the reserved status to the available status after
a locker hatch of the second access controlled delivery locker has been opened, or
after a set time period.

13. The elevator and access system according to claim 1, wherein the at least one first mobile phone is different from the mobile delivery communication device.

14. The elevator and access system according to claim 1, wherein the environment is a building.

15. The elevator and access system according to claim 1, wherein
the at least one first mobile phone is configured to communicate with the elevator control to forward second access data for a second access I/O device of a first access door of the environment to the mobile delivery communication device, and
the mobile delivery communication device is configured to unlock a door lock of the first access door using the second access data to enable access to the first access I/O device of the first access controlled delivery locker by a delivery person associated with the mobile delivery communication device.

16. The elevator and access system according to claim 1, wherein the at least one access controlled delivery locker is integrated to a landing door structure of an elevator within the environment.
